(19) United States
(12) Patent Application Publication
(10) Pub. No.: US 2013/0275147 A1
(43) Pub. Date: Oct. 17, 2013

(54) MEDICAL INFORMATION INTEROPERABILITY TESTING APPARATUS

(71) Applicants: TOSHIBA MEDICAL SYSTEMS CORPORATION, Otawara-Shi (JP); KABUSHIKI KAISHA TOSHIBA, Minato-ku (JP)

(72) Inventors: Kousuke SAKAUE, Nashushiobara-Shi (JP); Junichi TASHIRO, Otawara-Shi (JP)

(21) Appl. No.: 13/915,077

(22) Filed: Jun. 11, 2013

Related U.S. Application Data
(63) Continuation of application No. PCT/JP13/55191, filed on Feb. 27, 2013.

(30) Foreign Application Priority Data
Feb. 28, 2012 (JP) 2012-041744

(51) Int. Cl. G06Q 10/10; G06Q 50/22

(52) U.S. Cl. CPC G06Q 10/10; G06Q 50/22
USPC 705/2

(57) ABSTRACT

According to one embodiment, a medical information interoperability testing apparatus includes a setting information storage unit, a medical information storage unit, an information selection unit and a simulated communication unit. The setting information storage unit stores a plurality of pieces of communication setting information. The medical information storage unit stores medical information containing at least one of patient information, examination information, and image information. The information selection unit selects a piece of communication setting information to be used from the plurality of pieces of communication setting information. The simulated communication unit tests interoperability with a medical device as communication partner according to a medical communication protocol using the medical information and the piece of communication setting information to be used selected by the information selection unit.

### CROSS-REFERENCE TO RELATED APPLICATIONS

This application is a Continuation Application of No. PCT/JP2013/55191, filed Feb. 27, 2013, and the PCT application is based upon and claims the benefit of priority from Japanese Patent Application No. 2012-41744, filed Feb. 28, 2012, the entire contents of which are incorporated herein by reference.

### FIELD

Embodiments described herein relate generally to a medical information interoperability testing apparatus.

### BACKGROUND

In recent years, a method of performing data communication using a globally accepted medical communication protocol for exchanging data such as image information among a plurality of different medical devices has been used. Examples of medical communication protocols include a DICOM (Digital Imaging Communications and Medicine) standard for dealing with medical images captured by a CT (Computed Tomography) or an MRI (Magnetic Resonance Imaging), an HL7 (Health Level Seven) standard for mainly dealing with medical character information, and an MFER (Medical waveform Format Encoding Rule) standard for mainly dealing with medical waveforms such as an electrocardiogram (ECG), an electroencephalogram (EEG), and a respiratory waveform.

Unfortunately, a communication according to a predetermined medical communication protocol does not always ensure proper communication. For example, a communication between medical devices may cause data mismatch since the DICOM includes a predefined portion and a freely user-definable portion.

In order to solve such a problem, there have been attempts to preliminarily perform an interoperability test among medical devices to ensure that data is communicated correctly. Examples of the interoperability test include an interoperability test performed by bringing in a medical device to be connected to a user developing the medical device or to a site in which the medical device is installed; an interoperability test performed at a test event of the medical device to be connected; and other interoperability tests.

Unfortunately, the use of actual medical devices or other corresponding systems for a prior interoperability test involves a lot of constraints in terms of time, facility, place, and others, which prevents efficient testing. In addition, for example, a communication using a predetermined medical communication protocol such as a DICOM presumes a connection to a specified large number of medical devices for which all information is predefined and a test is generally performed on a specified medical device or a plurality of medical devices having common communication setting information. For this reason, the interoperability test requires specified medical device communication settings, and thus the interoperability test cannot be performed on an unspecified large number of medical devices. If an attempt is made to connect an unspecified large number of medical devices having other communication setting values, data may have a duplicate identifier or the medical device itself may have a duplicate identifier, thereby preventing correct communication.

In recent years, medical devices are connected to a general network such as the Internet using an Internet protocol so as to be transmittable and receivable to and from other medical devices. In this case, it is important to avoid various risks which may occur due to connection to a network.

IEC80001-1 is known as a risk management standard for networks incorporating this type of medical devices. This standard has three basic characteristics: patient safety, system effectiveness, and security of data and system by connecting medical devices to networks. This standard is intended to define the role, responsibilities, and processes required for risk management. For example, when an interoperability test is performed on medical devices, it is preferable to consider IEC80001-1 E.7 (confirmation of change application management and configuration management, and warranty definition) and E.8 (definition regarding risk management test on operating network).

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram illustrating a schematic configuration of a medical device interoperability testing system connected to a interoperability testing apparatus according to an embodiment of the present invention;

FIG. 2 is an explanatory drawing illustrating an example of additional information stored in the interoperability testing apparatus;

FIG. 3 is a functional block diagram illustrating an environment of the interoperability testing apparatus and a user environment for performing an interoperability test;

FIG. 4 is a flowchart illustrating a procedure for performing an interoperability test;

FIG. 5 is an explanatory drawing illustrating an example of a local configuration common table stored in a medical information storage unit;

FIG. 6 is an explanatory drawing illustrating an example of a local configuration user-specific table stored in a medical information storage unit;

FIG. 7 is an explanatory drawing illustrating an example of a remote configuration user-specific table stored in a medical information storage unit;

FIG. 8 is a flowchart illustrating a procedure for performing a workflow test from an order issue to an image acquisition;

FIG. 9 is an explanatory drawing illustrating an example of a medical device selection image;

FIG. 10 is an explanatory drawing illustrating an example of a connection setting image;

FIG. 11 is an explanatory drawing illustrating an example of a patient information acquisition image;

FIG. 12 is an explanatory drawing illustrating an example of a patient information registration image;

FIG. 13 is an explanatory drawing illustrating an example of an image acquisition image; and

FIG. 14 is an explanatory drawing illustrating an example of an image archive image.

### DETAILED DESCRIPTION

Hereinbelow, a description will be given of a medical information interoperability testing apparatus according to embodiments of the present invention with reference to the drawings.

In general, according to one embodiment, a medical information interoperability testing apparatus includes a setting information storage unit, a medical information storage unit, an information selection unit and a simulated communication unit. The setting information storage unit stores a plurality of pieces of communication setting information. The medical information storage unit stores medical information containing at least one of patient information, examination information, and image information. The information selection unit selects a piece of communication setting information to be used from the plurality of pieces of communication setting information. The simulated communication unit tests interoperability with a medical device as communication partner according to a medical communication protocol using the medical information and the piece of communication setting information to be used selected by the information selection unit.

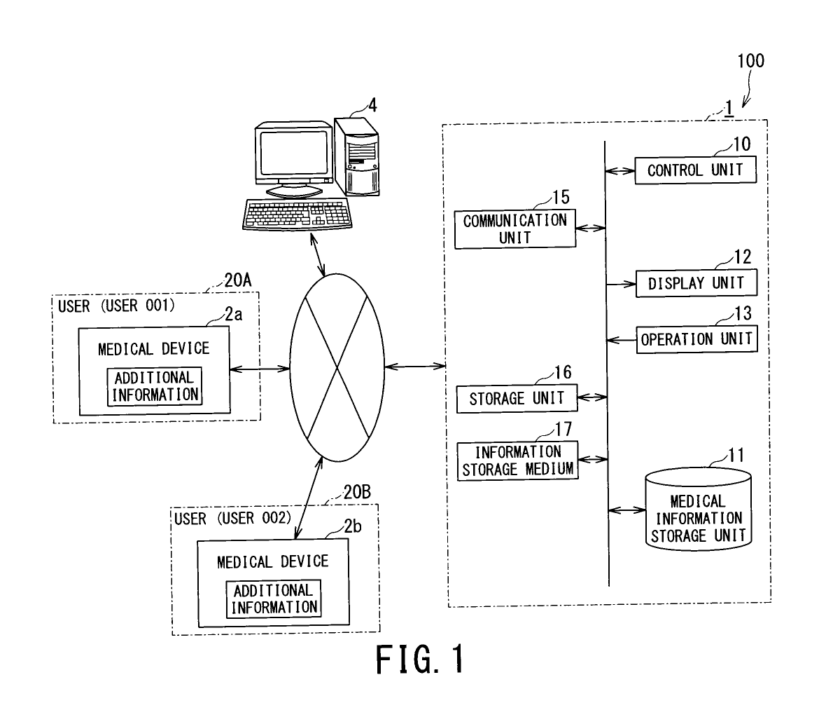

FIG. 1 is a block diagram illustrating a schematic configuration of a medical device interoperability testing system 100 connected to a interoperability testing apparatus 1 according to an embodiment of the present invention. The medical device interoperability testing system 100 includes the interoperability testing apparatus 1, a plurality of medical devices 2 (2a, 2b . . . ) corresponding to respective users 20 (20A, 20B . . . ), and a terminal 4, all of which are connected so as to be communicable with each other through a network communication.

Each medical device 2 is a medical device owned by a respective user 20 who is a vendor thereof. Examples of the medical device include a diagnostic imaging device for capturing patient medical images such as an MRI (Magnetic Resonance Imaging) device, an X-ray CT (Computed Tomography) device, an ultrasound diagnostic imaging device, a nuclear medicine diagnostic imaging device, a PET device, and a PET-CT device; or a medical information system such as an HIS (Hospital Information System), an RIS (Radiology Information System), and a PACS (Picture Archiving and Communication System). Note that the medical device 2 may not be an actual medical diagnostic imaging device, but instead may be a simulator thereof.

The medical device 2 can perform a medical device information communication to and from other medical devices. The medical device information communication is a message communication of medical information of patients among medical devices connected to each other through a network. The message communication is performed through a wired or wireless network line such as a LAN, a WAN, and the Internet. The medical device information communication uses a protocol specializing in communicating medical information such as a DICOM for mainly dealing with medical image information, an HL7 for mainly dealing with medical character information, and an MFER for mainly dealing with medical waveform information.

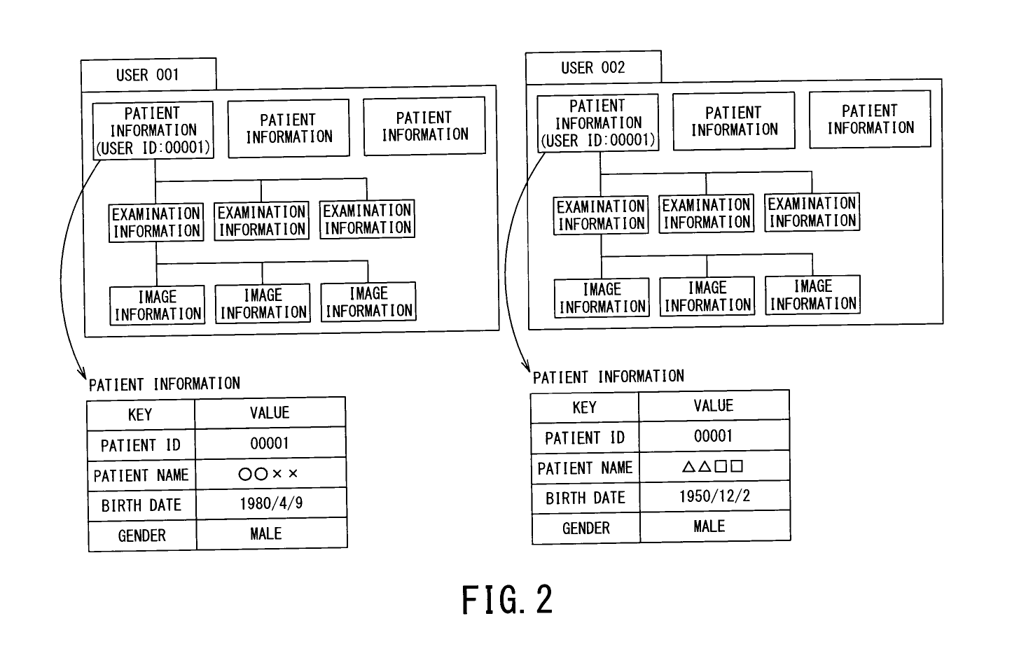

FIG. 2 is an explanatory drawing illustrating an example of additional information stored in the interoperability testing apparatus 1.

As illustrated in FIG. 2, the additional information is information hierarchically arranging user information (user ID), patient information, examination information, and image information. As an example of the additional information, FIG. 2 illustrates user IDs “user 001” and “user 002”. The patient information includes information such as a patient ID, a patient name, a birth date, and a gender. The examination information includes information such as a plurality of examination IDs and examination contents, and findings. The image information includes an image ID for identifying an image captured by an unillustrated diagnostic imaging device and corresponding image data.

The terminal 4 is mainly made of a personal computer or a workstation and is provided for a user to perform operations required for a interoperability test on the medical device 2 by the interoperability testing apparatus 1 such as logging in to the interoperability testing apparatus 1 via a network line and selecting the communication setting information by the interoperability testing apparatus 1. The detail will be described later.

The interoperability testing apparatus 1 is located at the site of a manufacturer manufacturing the medical device, which is a different site from the medical device 2 and the terminal 4. The interoperability testing apparatus 1 is intended to perform an interoperability test through a medical device information communication to and from the medical device 2. The interoperability testing apparatus 1 is configured so as to enable pseudo-implementation of a medical device information communication function corresponding to a diagnostic imaging device (CT or MRI) and a medical device information communication function corresponding to a medical information system (HIS, RIS, or PACS).

The interoperability testing apparatus 1 is made of a computer communicable via a network line and includes a control unit 10, a medical information storage unit 11, a display unit 12, an operation unit 13, a communication unit 15, a storage unit 16, an information storage medium 17, and other units. The display unit 12 is a display device such as a monitor. The operation unit 13 includes a keyboard, a mouse, and other devices for inputting data.

The storage unit 16 serves as a work area for the control unit 10, the communication unit 15, and other units, and can be implemented by a RAM (Random Access Memory) and other memory devices. The information storage medium 17 (computer-readable medium) is intended to store programs and data, and can be implemented by a hard disk drive or a memory device such as a flash memory and a ROM (Read Only Memory). The information storage medium 17 stores programs (programs for causing a computer to execute a process of each unit) for causing a computer to function as each unit of the present embodiment, a plurality of applications, and other information.

The communication unit 15 is connected to the terminal 4 and the medical devices 2a, 2b, . . . so as to be communicable with each other through a network. When a network connection is established with each medical device 2, the communication unit 15 performs communication with the each medical device 2 using a predetermined medical communication protocol such as a DICOM communication. The detail will be described later. In the following description, the present embodiment assumes that the DICOM communication is used as the medical communication protocol.

The medical information storage unit 11 stores communication setting information of each user and additional information of each medical device 2 received from the terminal 4 through the communication unit 15. The detail will be described later.

The control unit 10 is an arithmetic device performing an entire control and other various processes such as calculation and control. The functions of the control unit 10 can be implemented by hardware such as various processors (such as a CPU and a DSP) and an ASIC (such as a gate array), and programs. The control unit 10 performs various processes of the present embodiment based on the programs (data) stored in the information storage medium 17.

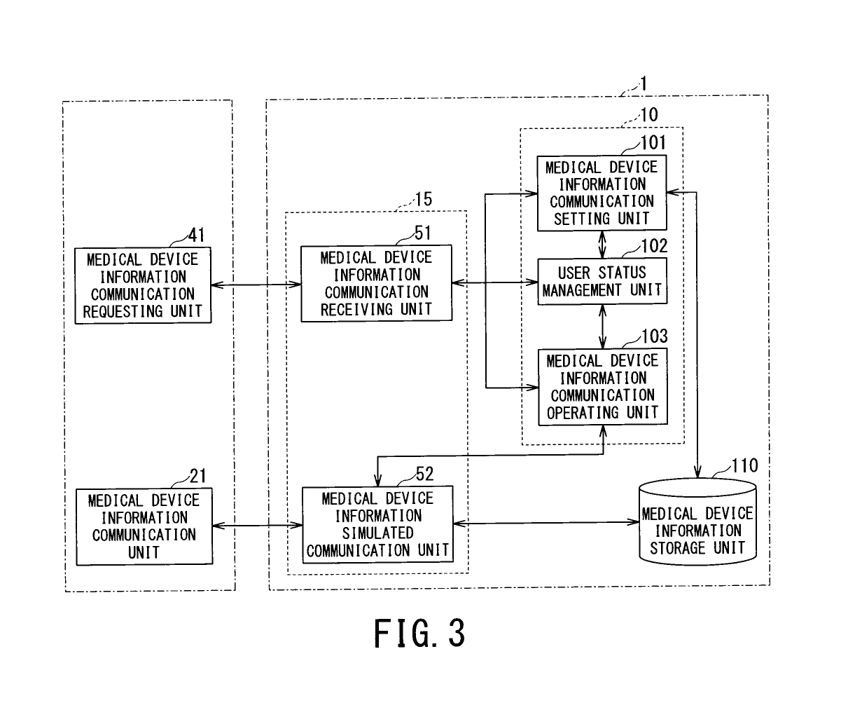

FIG. 3 is a functional block diagram illustrating an environment of the interoperability testing apparatus 1 and a user environment for performing an interoperability test. The user environment includes a medical device information communication requesting unit 41 and a medical device information communication unit 21. The medical device information communication requesting unit 41 is a unit included in the terminal 4 and makes a connection request to the interoperability testing apparatus 1 about an arbitrary user. The medical device information communication unit 21 is a communication unit included in the medical device 2 and performs a DICOM communication with the interoperability testing apparatus 1 based on the communication setting information of the medical device 2 in connection.

The environment of the interoperability testing apparatus 1 includes a medical device information communication receiving unit 51, a medical device information simulated communication unit 52, a medical device information communication setting unit 101, a user status management unit 102, a medical device information communication operating unit 103, and a medical device information storage unit 110.

The medical device information communication receiving unit 51 is a unit included in the communication unit 15, and starts a connection to the terminal 4 when a connection request is received from the medical device information communication requesting unit 41.

The medical device information communication setting unit 101, the user status management unit 102, and the medical device information communication operating unit 103 are units included in the control unit 10. The medical device information communication setting unit 101 performs communication setting based on communication setting information of a user about whom the medical device information communication receiving unit 51 received the connection request. The user status management unit 102 authenticates and manages the user about whom the medical device information communication requesting unit 41 makes the connection request. The medical device information communication operating unit 103 controls the communication between the interoperability testing apparatus 1 and the medical devices 2 based on the communication setting information of the user from whom the medical device information communication receiving unit 51 received the connection request.

The medical device information simulated communication unit 52 is a unit included in the communication unit 15, and performs a DICOM communication to the medical devices 2 based on the communication settings set by the medical device information communication setting unit 101. The medical device information storage unit 110 is a unit included in the medical information storage unit 11, and stores the communication setting information and the additional information of each medical device 2 held by the user.

### <Communication Information Setting and Interoperability Test>

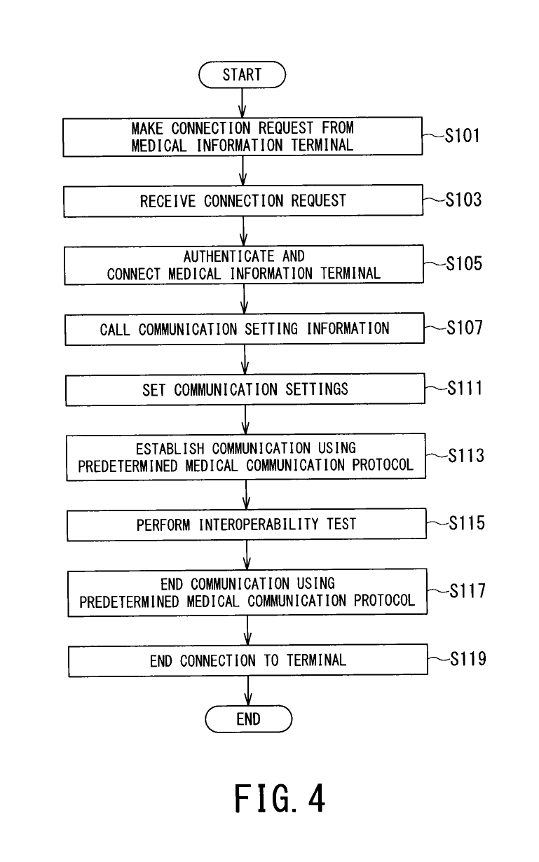

Now, an operation of the above configured interoperability testing apparatus 1 will be described with reference to the flowchart of FIG. 4. Note that FIG. 4 assumes that the interoperability testing apparatus 1 performs an interoperability test on the medical device 2a owned by the user 20A using a DICOM communication.

The medical device information storage unit 110 in the interoperability testing apparatus 1 preliminarily stores, for each user, communication setting information and additional information sent from the terminal 4.

The screen of the terminal 4 displays a Web browser which displays a log-in image to the interoperability testing apparatus 1. An operator of the user 20A inputs information for user authentication, i.e., information required for connection, such as the user identification ID “user001” and the password to the terminal 4. The medical device information communication requesting unit 41 in the terminal 4 makes a connection request with the information for user authentication, for instance including the user identification ID “user001”, to the interoperability testing apparatus 1 according to the inputted information (step S101). The medical device information communication receiving unit 51 in the interoperability testing apparatus 1 receives the connection request with the information for user authentication from the terminal 4 through the Internet in step S101 (step S103). The user status management unit 102 authenticates the user identification ID “user001” of the user who made the connection request, and establishes the connection to the terminal 4 (step S105).

Then, the medical device information communication setting unit 101 calls the communication setting information for the DICOM communication of the medical device 2a stored in the medical device information storage unit 110 (step S107), and set the information to the interoperability testing apparatus 1 (step S111).

Then, the medical device information communication operating unit 103 establishes the DICOM communication to the medical device information communication unit 21 of the medical device 2a through the medical device information simulated communication unit 52 based on the communication setting information for the DICOM communication in the medical device 2a set in step S111 (step S113).

Then, the interoperability testing apparatus 1 performs an interoperability test to check whether the DICOM communication to and from the medical device 2a is performed correctly or not (step S115). For example, when an arbitrary patient ID is sent from the terminal 4 to request the corresponding image information, the medical device information communication receiving unit 51 in the interoperability testing apparatus 1 receives this request. Then, the medical device information communication setting unit 101 calls the image information corresponding to the patient ID of the user 20A called from the medical device information storage unit 110. Then, the medical device information communication operating unit 103 sends the image data corresponding to the patient ID to the medical device 2a through the medical device information simulated communication unit 52 using the DICOM communication. When the image information corresponding to the patient ID is received, the medical device information communication unit 21 of the medical device 2a sends a reception notification to the interoperability testing apparatus 1.

When the interoperability test in step S115 ends, the medical device information simulated communication unit 52 in the interoperability testing apparatus 1 ends the DICOM communication to the medical device information communication unit 21 of the medical device 2a (step S117). The operator of the user 20A operating the terminal 4 logs out to end the connection to the interoperability testing apparatus 1 (step S119).

Note that the communication setting information may be stored in the medical device information storage unit 110 for each user so as to select and switch the communication setting information according to the user, or the communication setting information may further be stored separately for each modality so as to select and switch the communication setting information according to the modality. Alternatively, a plurality of pieces of communication setting information may be stored for one user so as to select the communication setting information used by the user and switch the communication setting information used for the interoperability test.

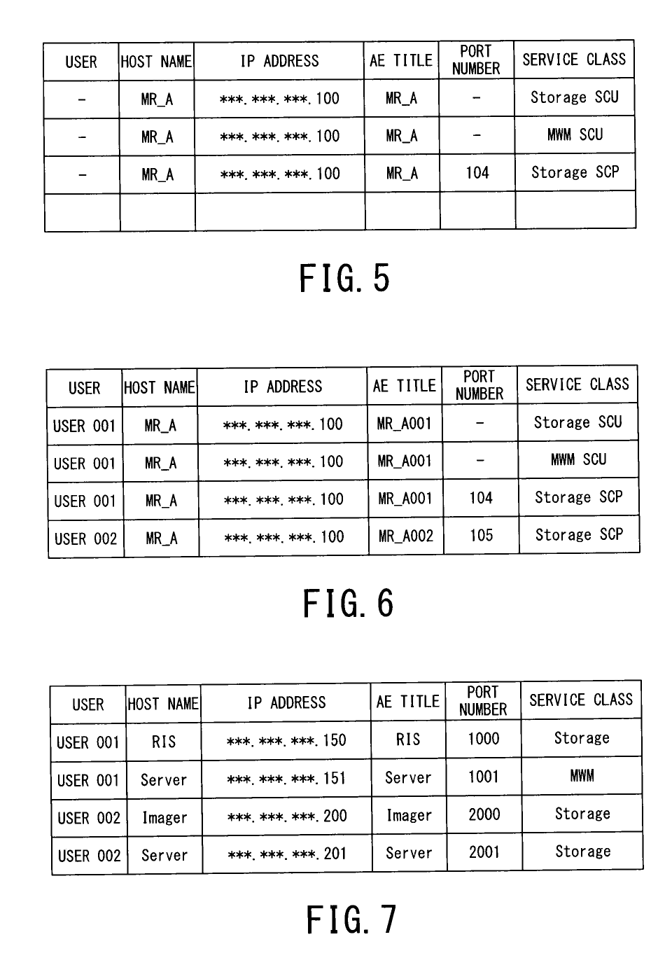

FIGS. 5, 6, and 7 illustrate an example of communication setting information for the DICOM communication stored in the medical device information storage unit 110 to perform an interoperability test to and from each medical device 2a, 2b, . . . Before the interoperability test is performed, the interoperability testing apparatus 1 configures communication setting information to be performed in a case in which the interoperability testing apparatus 1 is a predetermined modality as illustrated in FIGS. 5 and 6 in order to play a role of a modality such as an MRI, and stores the configured communication settings in the medical device information storage unit 110. In addition, the medical device 2 is a medical information system device such as an RIS and a PACS or a simulator thereof, and thus the communication setting information is configured as illustrated in FIG. 7 for each medical information system device and is stored in the medical device information storage unit 110.

FIG. 5 is a local configuration common table containing common communication setting information not related to a specific user set at a side of the interoperability testing apparatus 1. FIG. 6 is a local configuration user-specific table containing communication setting information specific to each user set at a side of the interoperability testing apparatus 1. The local configuration common table and the local configuration user-specific table contain users, host names, IP addresses, AE titles, port numbers, and service classes. The “user” contains an identification ID of the user. The local configuration common table contains communication setting information not related to a specific user, and thus the “user” column does not contain a specific user identification ID. In contrast to this, the local configuration user-specific table contains communication setting information specific to a user, and thus contains communication setting information for each user. The “host name” contains IDs for identifying the modality. For example, “MR_A” indicates a device having an ID, that is, “A” of the modality “MRI”. The “AE title” is a specific ID for identifying a medical device, such as a specific modality for performing a DICOM communication to and from the medical devices 2a, 2b In the local configuration common table, the AE title matches the host name. In the local configuration user-specific table, communication setting information needs to be identified for each user, and thus the

AE title is assigned such that “MR_A” is followed by a user identifying number (such as “001” and “002”). The “service class” indicates classes of communication services in the DICOM communication. For example, “Storage SCU” indicates sending the image to the user, “MWM SCU” indicates sending the query information to the user, and “Storage SCP” indicates sending the image to the provider.

FIG. 7 is a remote configuration user-specific table containing communication setting information for identifying the remote medical devices 2a, 2b, . . . as the communication partner. Like the local configuration common table and the local configuration user-specific table, the remote configuration user-specific table also contains users, host names, IP addresses, AE titles, port numbers, and service classes. In the remote configuration user-specific table, “host name” includes medical information systems such as an RIS and a PACS; and “AE title” includes specific IDs for identification such as a specific RIS and a PACS for performing a DICOM communication to and from the interoperability testing apparatus 1. In the present embodiment, the host name matches the AE title, assuming one device for one type in the medical information system. The items other than “host name” and “AE title” are the same as those in the local configuration common table and the local configuration user-specific table.

As is apparent from FIGS. 5 to 7, the interoperability testing apparatus 1 switches the communication setting information to be used for the interoperability test according to the user ID or the modality, or by the user selecting one of a plurality of pieces of communication setting information associated with one user ID. Alternatively, identification information (ID) may be preliminarily assigned to each of the communication setting information so as to switch the communication setting information based on the identification information.

Thus, for example, when the communication setting information is switched according to the user ID, the interoperability testing apparatus 1 according to the present embodiment can identify data of the same patient ID “00001” for each user ID in an easy and accurate manner without causing duplication even if users identified by a different user ID deal with the same patient ID “00001”.

### <Workflow Test>

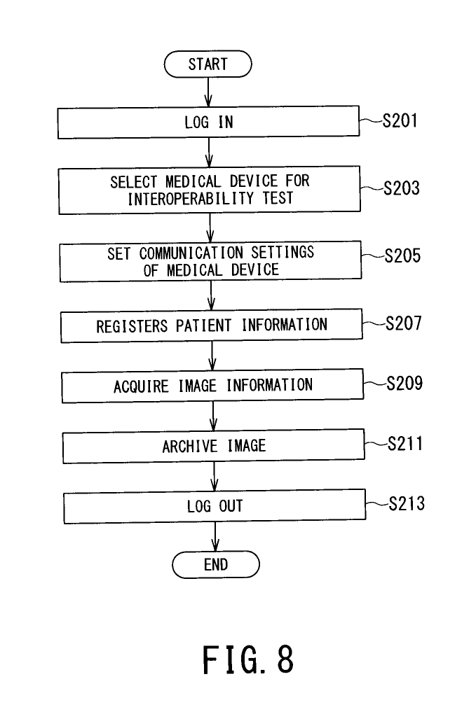

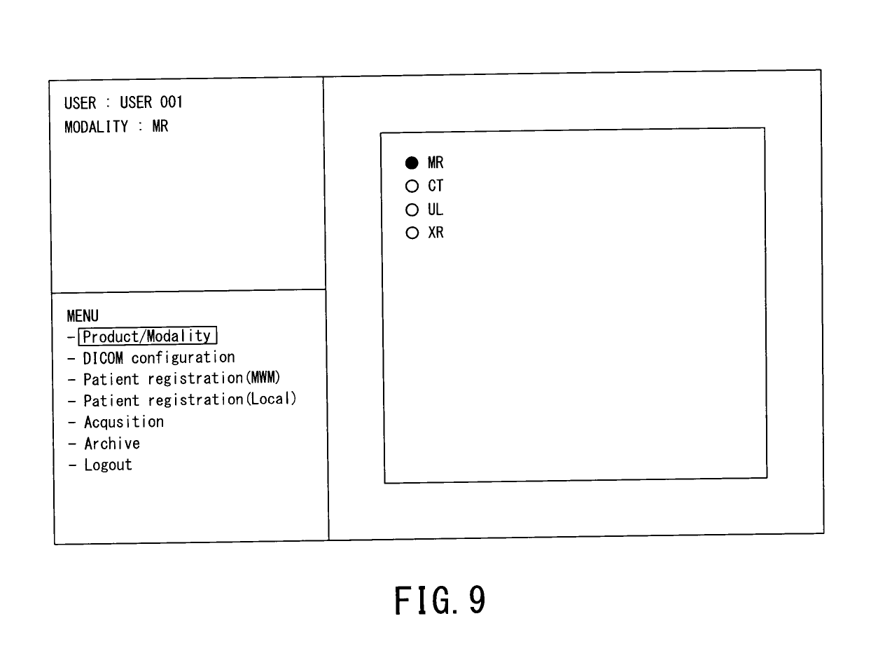

A procedure for performing a workflow test from an order issue to an image acquisition by a radiologist using the interoperability testing apparatus 1 will be described with reference to a flowchart in FIG. 8 and screen display examples in FIGS. 9 to 14. Note that FIGS. 9 to 14 illustrate input images for various setting items displayed on a screen of the terminal 4. The identification ID of the user performing the interoperability test and the modality name are displayed on the upper left of the image, the menu items of the setting image is displayed on the lower left of the image, and the setting image for input is displayed on the right side of the image.

The radiologist operates the terminal 4 to log in to the interoperability testing apparatus 1 with the user identification ID “user001” to obtain authentication (step S201). The medical device selection image illustrated in FIG. 9 is displayed on the terminal 4. The radiologist selects a modality for the interoperability test from the medical device selection image illustrated in FIG. 9 (step S203). When the radiologist selects “MR” on the right side of the image to perform the interoperability test to and from the MRI, “MR” is entered in the “Modality” column on the upper left of the image as illustrated in FIG. 9.

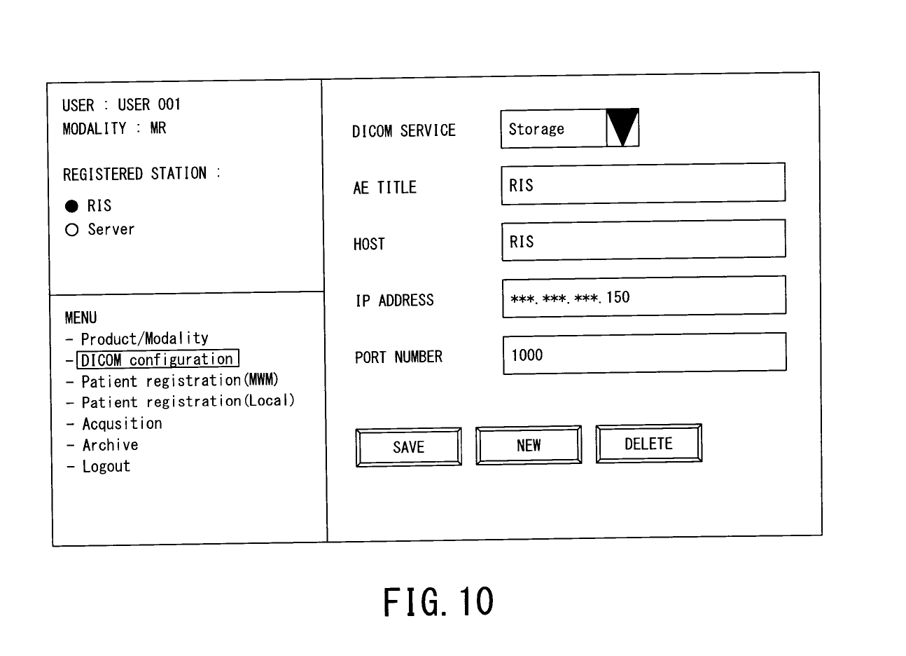

Then, when the radiologist selects a connection setting from the menu items on the lower left of the image, a connection setting image is displayed on the terminal 4 as illustrated in FIG. 10. The radiologist inputs a setting of the medical device 2 to be connected to the interoperability testing apparatus 1 (step S205). In an example of FIG. 10, the radiologist inputs the IP address “***.***.***.100” and the port number “1000” for “Storage” service in the case where the medical device 2 is “RIS”. When the “Save” button is pressed, the inputted setting values are stored in the medical device information storage unit 110.

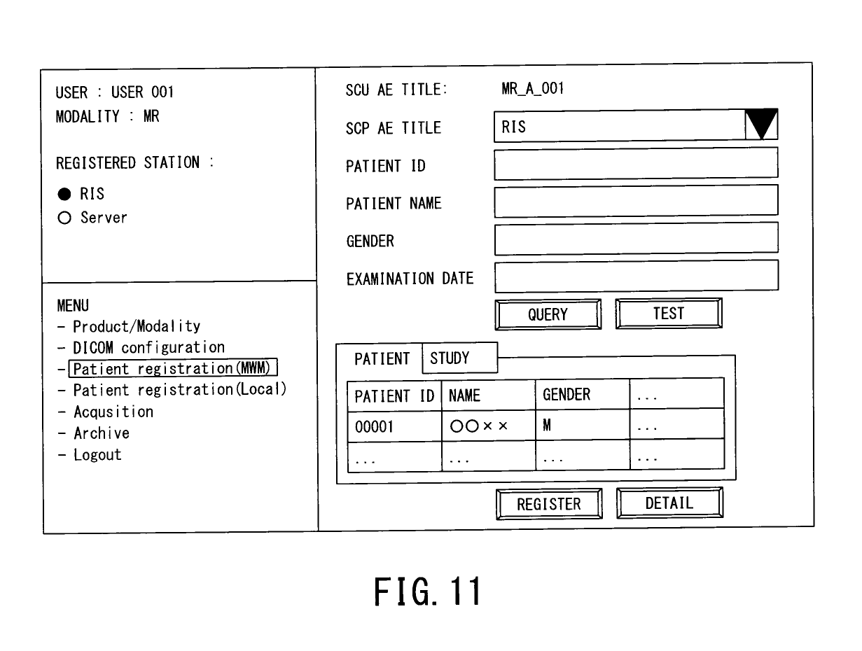

Then, the radiologist registers the patient information (step S207). For example, when the radiologist selects the patient information acquisition setting from the menu items to acquire the patient information pre-registered for the RIS connected on the network, a patient information acquisition image is displayed on the terminal 4 as illustrated in FIG. 11. When the radiologist selects “RIS” from the “SCP AE Title” column and inputs any one of the “Patient ID”, “Patient name”, “Gender”, and “Examination date” as a search condition, and then presses the “Query” button, the patient information matching the search condition is searched from the database of the RIS, and the search results are displayed on the lower portion of the image. When the radiologist selects the desired patient information from the search results and presses the “Register” button, the selected patient information is stored in the medical device information storage unit 110. Note that when the radiologist selects the patient information and presses the “Detail” button, the detail of the selected patient information is displayed.

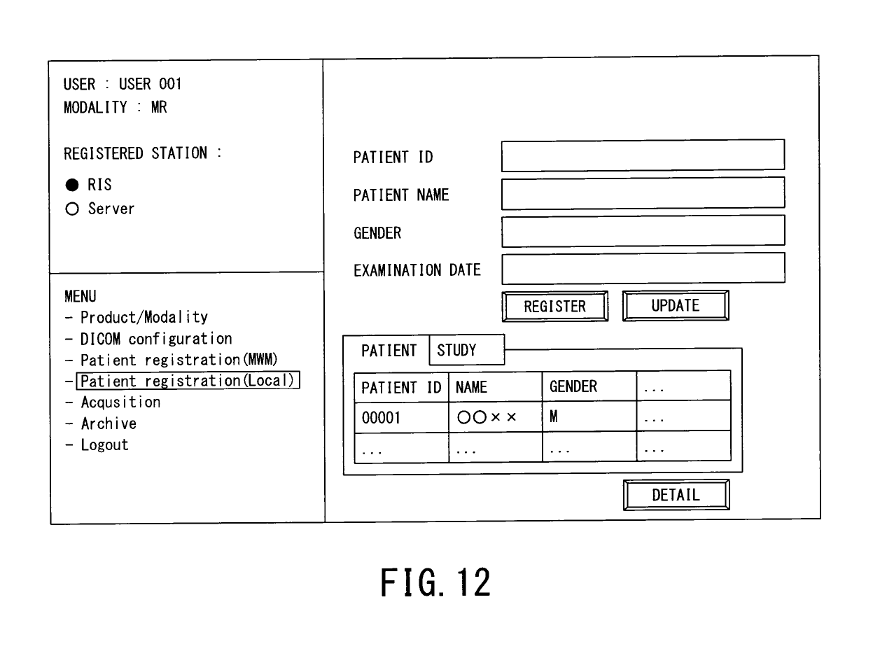

In a case where patient information not registered in the RIS is used, when the radiologist selects an arbitrary registration of the patient information from the menu items, the patient information registration image is displayed on the terminal 4 as illustrated in FIG. 12. Then, when the radiologist inputs “Patient ID”, “Patient name”, “Gender”, and “Examination date” and then presses the “Register” button, the information is stored as the patient information in the medical device information storage unit 110 and the registration information is displayed on the lower portion of the image.

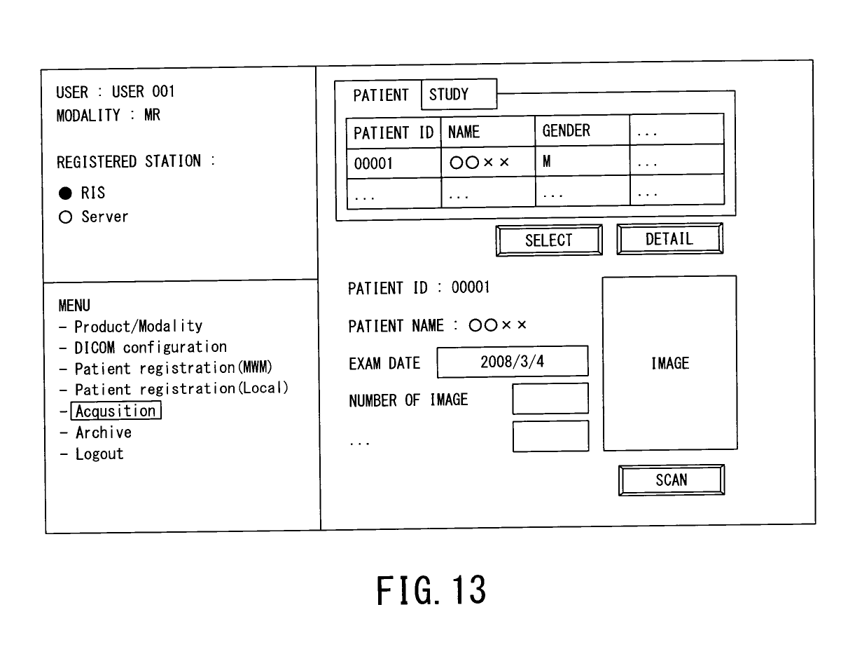

Then, when the radiologist selects an image acquisition from the menu items, an image acquisition image is displayed on the terminal 4 as illustrated in FIG. 13. The patient information registered in step S207 is displayed on the upper portion of the image. When the “Select” button is pressed to select arbitrary patient information, a plurality of pieces of image information corresponding to the patient ID stored in the medical device information storage unit 110 is called and displayed on the “Image column”. In the case of the interoperability test, the image information displayed on the “Image” column may be a dummy image stored in the medical device information storage unit 110 of the interoperability testing apparatus 1. When the radiologist presses the “Scan” button on the lower portion of the “Image” column, the selected patient information is associated with the image displayed on the “Image” column (step S209).

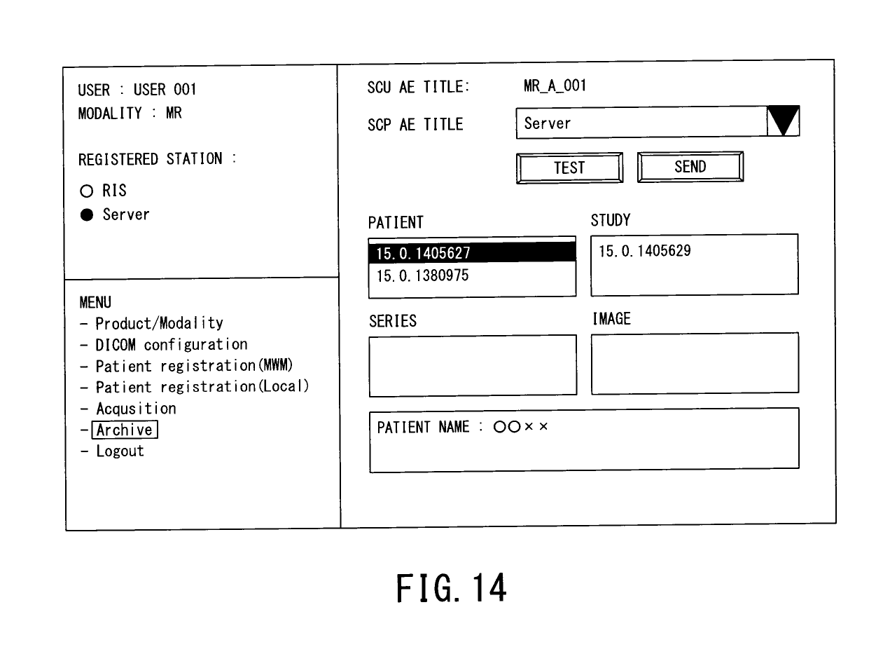

Finally, when an image archive is selected from the menu items, an image archive image is displayed on the terminal 4 as illustrated in FIG. 14. When the radiologist selects any one of the items displayed on the “Patient”, “Study”, “Series”, and “Image” columns, and selects “Server” as the “SCP AE Title”, and then presses the “Send” button, the image information associated with the arbitrary patient information in step S209 is sent from the interoperability testing apparatus 1 to the medical device 2, and the image is archived in the medical device 2 (step S211).

When the image is archived in the medical device 2 in step S211, the terminal 4 ends the connection to the interoperability testing apparatus 1 and logs out (step S213).

According to the aforementioned embodiment, when a interoperability test is performed on a medical device, the communication setting information and the additional information of the medical device based on a predetermined medical communication protocol of the medical device is preliminarily sent to the interoperability testing apparatus 1 and is stored for each user; and the medical device performs communication with the interoperability testing apparatus 1 using the predetermined medical communication protocol based on the communication setting information of itself. Thus, even if an interoperability test is performed on an unspecified large number of medical devices, duplicate communication setting information and duplicate additional information can be prevented by communication setting and communication control.

In addition, the interoperability testing apparatus 1 according to the present embodiment can perform an interoperability test on a medical device owned by each user without installing the actual medical device in the interoperability testing environment. Thus, the user can perform an interoperability test on the medical device owned by the user whenever it is convenient for the user, which is very highly convenient.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A medical information interoperability testing apparatus comprising:
a setting information storage unit configured to store a plurality of pieces of communication setting information;
a medical information storage unit configured to store medical information containing at least one of patient information, examination information, and image information;
an information selection unit configured to select a piece of communication setting information to be used from the plurality of pieces of communication setting information; and
a simulated communication unit configured to test interoperability with a medical device as communication partner according to a medical communication protocol using the medical information and the piece of communication setting information to be used selected by the information selection unit.

2. The medical information interoperability testing apparatus according to claim 1, wherein
the medical information storage unit stores a plurality of pieces of medical information; and
the information selection unit selects a piece of medical information to be used from the plurality of pieces of medical information.

3. The medical information interoperability testing apparatus according to claim 1, wherein
the communication setting information contains local configuration information which is a set of local settings including settings of an AE title and a DICOM service class; and
the information selection unit selects a piece of local configuration information to be used from a plurality of pieces of local configuration information.

4. The medical information interoperability testing apparatus according to claim 1, wherein
the communication setting information contains remote configuration information which is a set of settings indicating the communication partner including settings of an AE title and a DICOM service class; and
the information selection unit selects a piece of the remote configuration information to be used from a plurality of pieces of remote configuration information.

5. The medical information interoperability testing apparatus according to claim 1, wherein
the information selection unit selects the piece of communication setting information to be used based on at least one of user identification information, identification information of the medical device as the communication partner, and identification information of the communication setting information.

6. The medical information interoperability testing apparatus according to claim 1, further comprising a terminal communication processing unit configured to perform communication with a terminal device through a network, a process of receiving information for user authentication, and a process of registering and changing the communication setting information stored in the setting information storage unit.
